(19) United States
(12) Patent Application Publication
(10) Pub. No.: US 2018/0295405 A1
(43) Pub. Date: Oct. 11, 2018

(54) Portable Set Top Box and Internet of Things Controller with Laser Projection System

(71) Applicant: CenturyLink Intellectual Property LLC, Denver, CO (US)

(72) Inventors: Thomas C. Barnett, JR., Monroe, LA (US); Aamir Hussain, Monroe, LA (US)

(21) Appl. No.: 15/858,744

(22) Filed: Dec. 29, 2017

Related U.S. Application Data
(60) Provisional application No. 62/485,158, filed on Apr. 13, 2017.
(60) Provisional application No. 62/483,049, filed on Apr. 7, 2017.

(51) Int. Cl. H04N 21/41; H04N 21/436; H04N 21/422

(52) U.S. Cl. CPC H04N 21/4122; H04N 21/42203; H04N 21/43615

(57) ABSTRACT

Disclosed embodiments include set-top box (STB) devices, systems and apparatus providing integrated video projection and Internet of Things (IoT) control functionality. Device embodiments include an internal power supply, logic and wireless radios providing for connection to various networks. Therefore, device embodiments are portable and typically provided in a small housing. Alternative embodiments include methods of providing STB, video projection and IoT control functionality with a relatively small and easily transported self-contained, self-powered device.

### CROSS-REFERENCES TO RELATED APPLICATIONS

This application claims priority to U.S. Provisional Patent Application Ser. No. 62/485,158 filed Apr. 13, 2017 by Thomas C. Barnett, Jr. and titled, “Portable Set Top Box and Internet of Things (IoT) Controller with Laser Projection System” (attorney docket no. 020370-032802US) and U.S. Provisional Patent Application Ser. No 62/483,049 filed Apr. 7, 2017 by Thomas C. Barnett, Jr. and titled, “Portable Set Top Box and Internet of Things (IoT) Controller with Laser Projection System” (attorney docket no. 020370-032801US), the entire teachings of which are incorporated herein by reference in its entirety.

This application may be related to the following: U.S. patent application Ser. No. 15/370,764 filed Dec. 6, 2016 by Thomas C. Barnett, Jr. and titled, “Internet of Things (IoT) Human Interface Apparatus, System, and Method” (attorney docket no. 020370-028400US) which claims priority to Ser. No. 62/342,710 filed May 27, 2016 by Thomas C. Barnett, Jr. and titled, “Internet of Things (IoT) Human Interface Apparatus, System, and Method” (attorney docket no. 020370-028401US), and U.S. patent application Ser. No. 15/385,667 filed Dec. 20, 2016 by Thomas C. Barnett, Jr. et al. and titled, “Internet of Things (IoT) Personal Tracking Apparatus, System, and Method” (attorney docket no. 020370-029200US).

The respective disclosures of these applications/patents (which this document refers to collectively as the “Related Applications”) are incorporated herein by reference in their entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, apparatus, and computer software for implementing Internet of Things functionality, and, in particular embodiments, to methods, systems, apparatus, and computer software for implementing a fully portable set top box (STB) having Internet of Things (“IoT”) control functionality and an integrated projection system.

### BACKGROUND

Although there are various set-top boxes and projectors currently on the market and being used by consumers, such conventional devices are not fully-portable and do not provide for interconnectedness with and control of local or remote IoT devices. The embodiments disclosed herein are designed to minimize one or more of the above problems.

### SUMMARY

Certain embodiments disclosed herein include robust and scalable solutions for implementing set-top box (STB), video projection and Internet of Things (IoT) control functionality. Several embodiments disclose methods, systems, apparatus, devices and computer software for implementing highly integrated and portable STB, video projection and IoT control functionality with a relatively small and easily transported self-contained, self-powered device.

Specific STB embodiments include a processor, an input device in communication with the processor, and a video projection module in communication with the processor. The STB may also include a radio transceiver and a non-transitory computer readable medium in communication with the processor. The computer readable medium will store instructions that, when executed by the processor, cause the STB to function as a set-top box, video projection system, and Internet of Things (IoT) controller. For example, the STB may receive an input from a user that is processed to cause the video projection module to project video output. A second input can cause the radio transceiver to output a signal to control a separate IoT device.

The described devices and methods support several different types of input device including but not limited to buttons, switches and microphones. Thus, the input may be a voice command received with a microphone. Additional input may be provided wirelessly or over a wired connection.

Certain STB embodiments also include a battery positioned within the device housing to power to the processor, input devices, video projection module, radio transceiver and other elements. The battery and other power supply elements provide device embodiments with full portability. STB embodiments operate as a conventional set-top box. For example, an apparatus may, in response to instructions from user, transmit a television or video signal to a separate video monitor over a wired or wireless connection.

Certain device embodiments are fully portable. Therefore, user instructions received by the STB can cause the STB to identify a local network over which the STB is not initially communicating, identify one or more IoT devices communicating over the local network, and configure the internal radio transceiver to communicate over the local network. Then, the STB may be utilized to output a signal to control at least one of the IoT devices communicating over the local network. Alternative STB embodiments may output a signal to a local network to control at least one remotely located IoT device over the local network and over the Internet.

Device embodiments may also receive data over a network. For example, a STB embodiment may receive video data over the local network, process the video data to create video output, and project the video output from the projector module. The disclosed embodiments may also operate as a wireless access point for a local network.

Certain device embodiments include one or more integrated audio speakers. A device base may be included that defines a reflecting surface configured to horizontally disperse audio output from the speaker.

Alternative embodiments include methods of providing set-top box functionality, video or image projection functionality, and IoT control functionality with one relatively small, typically portable STB device. Method embodiments generally include providing a STB, having at least IoT control and integrated projector functionality. The STB may receive input from a user through any manner of switch, keyboard, remote control, microphone receiving voice commands, or similar apparatus. The input may be processed to cause the STB to project optical output from the projector. Method embodiments may further include receiving additional input from the user that is processed to cause the STB to control an IoT device.

As noted above, certain STB embodiments described herein are fully integrated and portable devices. Thus, a user may transport the STB from place to place in much the way that a conventional laptop computer is transported. If the user transports an STB embodiment to a location where the STB has not yet been connected to a network, method embodiments may include identifying a local network over which the STB is not initially communicating. In addition, the STB may identify one or more local IoT devices communicating over the identified local network. The STB may then configure one or more radio transceivers to communicate over the local network. Alternatively, or in addition, the STB may configure communications with any number of IoT devices using, for example Bluetooth or another direct wireless communications method.

Communication over the local network may involve both data or signal download and upload processes. For example, a signal may be output from the STB to control at least one of the IoT devices communicating over the local network. Alternatively, the STB may receive video data, computer files, or other data that can be displayed from the local network. Data received over the local network may be processed by the STB to produce video, graphical data, or other image output.

Various modifications and additions can be made to the embodiments discussed without departing from the scope of the invention. For example, while the embodiments described above refer to particular features, the scope of this invention also includes embodiments having different combination of features and embodiments that do not include all of the above described features.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1A is a top plan view of an Internet of Things (“IoT”) enabled set box (“STB”) in accordance with various embodiments.

FIG. 1B is a side elevation view of the STB of FIG. 1A.

FIG. 1C is a front elevation view of the STB of FIG. 1A.

FIG. 1D is a rear elevation view of the STB of FIG. 1A.

FIG. 2 is a block diagram of an IoT enabled STB in accordance with various embodiments.

FIG. 3 is a schematic diagram illustrating various systems for implementing Internet of Things (“IoT”) STB, in accordance with various embodiments.

FIG. 4 is a schematic diagram illustrating another system for implementing IoT STB functionality, in accordance with various embodiments.

FIGS. 5A-5B are flow diagrams illustrating methods for implementing IoT STB functionality, in accordance with various embodiments.

FIG. 6 is a block diagram illustrating an exemplary computer or system hardware architecture, in accordance with various embodiments.

FIG. 7 is a block diagram illustrating an example of a networked system of computers, computing systems, or system hardware architecture, which can be used in accordance with various embodiments.

### DETAILED DESCRIPTION OF CERTAIN EMBODIMENTS

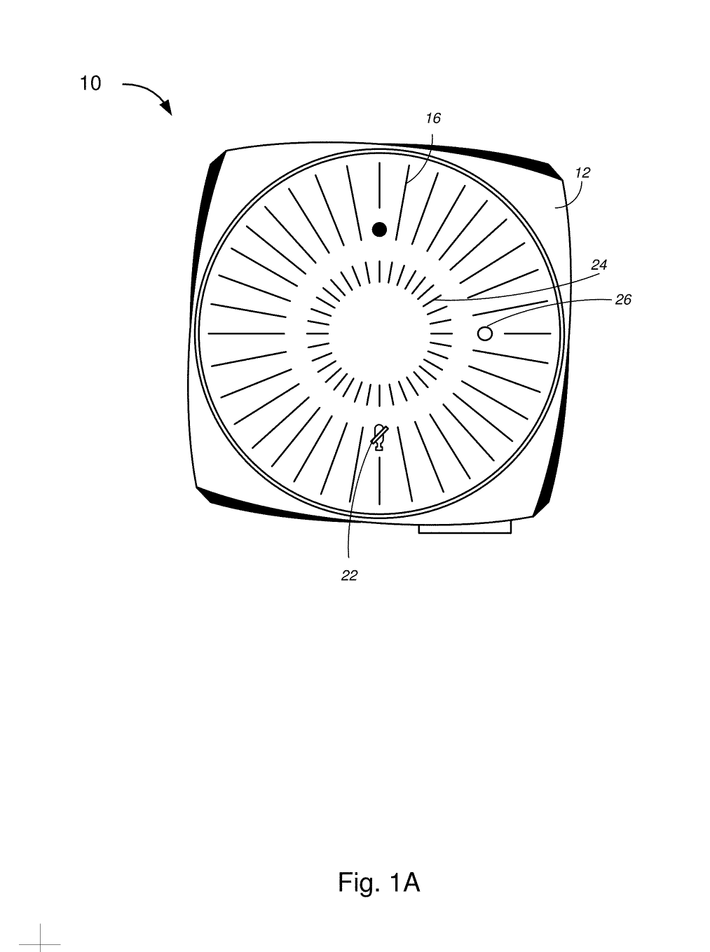

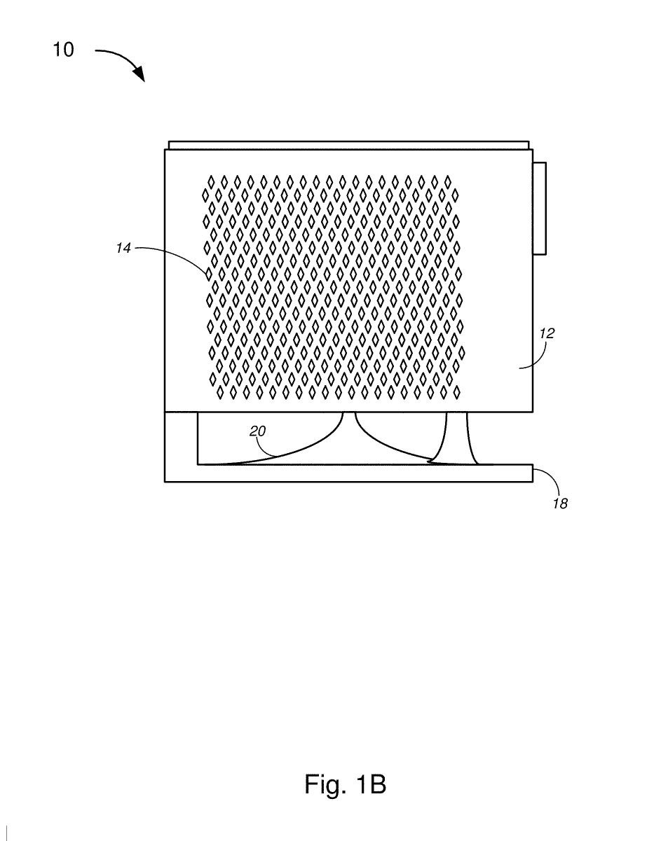

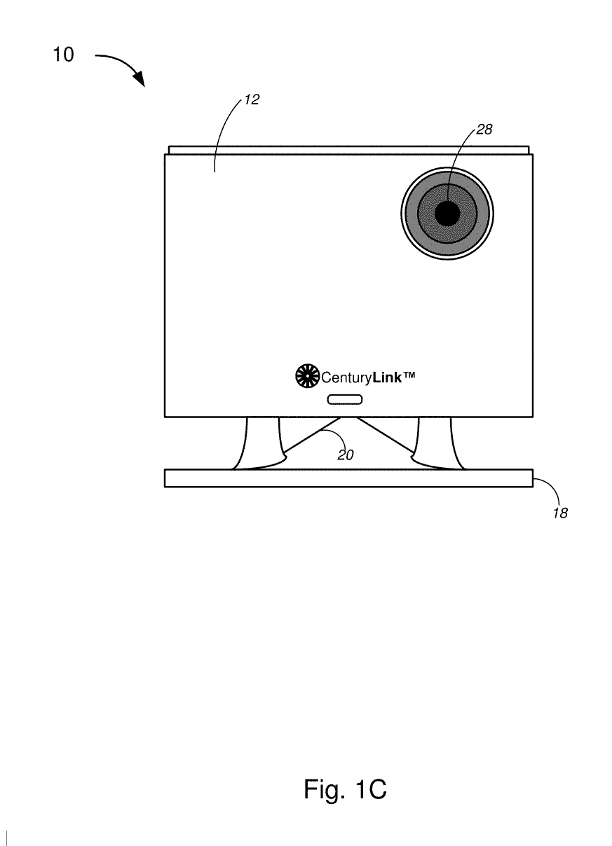

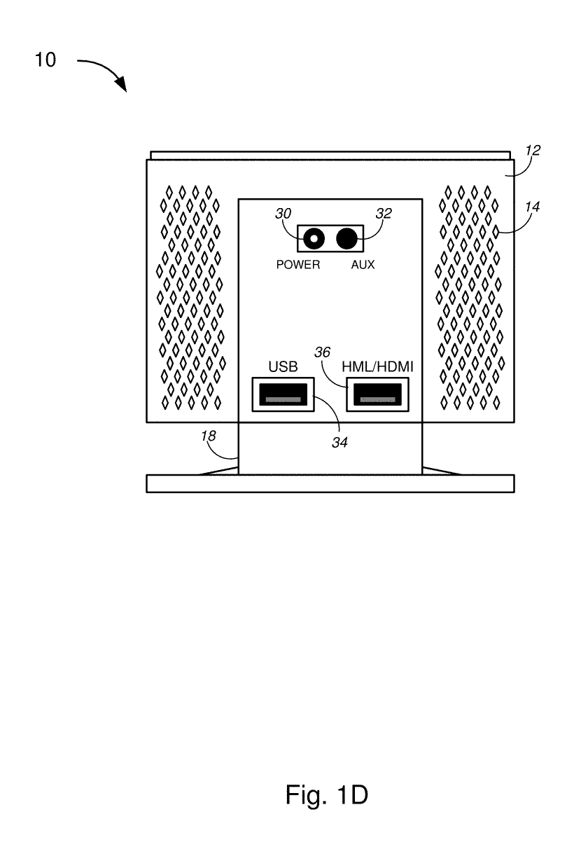

We now turn to the embodiments as illustrated by the drawings. FIGS. 1-7 illustrate some of the features of a system, device, or method for implementing highly integrated and portable set top box (“STB”), video projection and Internet of Things (“IoT”) control functionality. The methods, systems, and devices illustrated by FIGS. 1-7 refer to examples of different embodiments that include various components and steps, which can be considered alternatives, or which can be used in conjunction with one another in the various embodiments. The description of the illustrated methods, systems, and apparatuses shown in FIGS. 1-7 is provided for purposes of illustration and should not be considered to limit the scope of the different embodiments.

FIGS. 1A-1D are views of a representative highly integrated and portable STB, video projection and IoT control unit 10, (generally referred to herein as STB 10). Specifically, FIG. 1A is a top plan view, FIG. 1B is a side elevation view, FIG. 1C is a front elevation view, and FIG. 1D is a rear elevation view of a representative STB 10. As illustrated in FIGS. 1A-1D, the STB 10 includes a housing 12 which supports and houses internal or surface mounted components. Selected surfaces of the housing 12 may be perforated with holes or slots to provide ventilation for internal components and for the transmission of sound. See for example, the holes 14 illustrated in FIG. 1B, or the slots 16 of FIG. 1A.

The housing 12 of the STB 10 may include or be supported by an integrated or separate stand 18, which stand may, in certain embodiments define an acoustic reflecting surface such as the base reflex cone 20 shown in FIG. 1B or 1C. The base reflex cone 20 can acoustically cooperate with one or more speakers within, or outside the STB 10 is described below, to reflect sound energy and distribute sound in an acoustically advantageous manner.

One or more surfaces of the housing 12 may include input devices such as control switches, microphones or buttons. Representative input devices include, but are not limited to a mute button 22 and multipurpose switch 24 illustrated in the figures on the top surface of the STB 10. The mute button 22, for example, may be used to temporarily mute or enable audio input or output. The multipurpose switch 24 may, in certain embodiments, be a touch sensitive control, set of arrow keys, or similar apparatus providing for the control of volume, projector output brightness, and other functions as described herein. Mechanical input devices may be included on any surface of the STB 10 or within the interior of the STB 10, and may be implemented with any manner of switch, control surface, touchpad or other tactile input device. In certain embodiments a keyboard or mouse, which may be a wireless keyboard or mouse, may function as an input device. Other alternative input devices include one or more microphones as described below. Remote controls operating with optical emitters or radio frequency emitters may also be implemented as input devices. Thus, input to the STB 10 may be accomplished manually, optically, over radio frequency transmissions, or through sound, for example with user's voice.

One or more surfaces of the housing 12 may also include any number of sensors, for example, ambient light sensor 26 shown on the top surface of the STB 10. Other sensors, including but not limited to, temperature, sound, or motion sensors as described herein may be optionally included on any surface of the STB 10.

As described in detail below, the STB 10 is an integrated and portable device with all subsystems required for power, video projection, customary STB functions, audio output and IoT control functionality incorporated into one device having one housing. The STB 10 may communicate wirelessly with any number of local or remote IoT devices. As used herein a local IoT device communicates with the STB 10 over a local network, for example a home network. A remote IoT device communicates with the STB 10 over the Internet, in conjunction with other intervening networks of various types. Typically, a remote IoT device will be located in a different building, house, or office, for example than the STB 10.

The STB 10 may communicate with a separate television, monitor or other display and provide video content, still pictures images, television and associated audio content to the separate television or monitor. Thus, the STB 10 may function as a conventional STB. In addition, video content, still pictures, images or other data may alternatively (or may also) be directly projected from the STB 10 from an integrated projection module. For example, the STB 10 may, as illustrated in FIG. 1C, may include a projector 28 extending from or projecting through the housing 12. The projector 28 may, as described in detail below, project content using any configuration of optical elements, lenses, illumination sources and control electronics. Projection may be to any projection surface, screen, or medium suitable for receiving optical projection.

The STB 10 further includes various connection ports, sockets, inputs or other devices accessible to a user through or at the housing 12. For example, the STB 10 may include a DC voltage port 30 providing a connection point for a power supply, charger or other electronic device for charging one or more batteries within the STB 10. The STB 10 may also include various input/output connections including but not limited to an auxiliary audio output jack 32, one or more USB ports 34, one or more HML/HDMI video ports 36, or the like for the wired connection of external speakers, devices, monitors, or other apparatus.

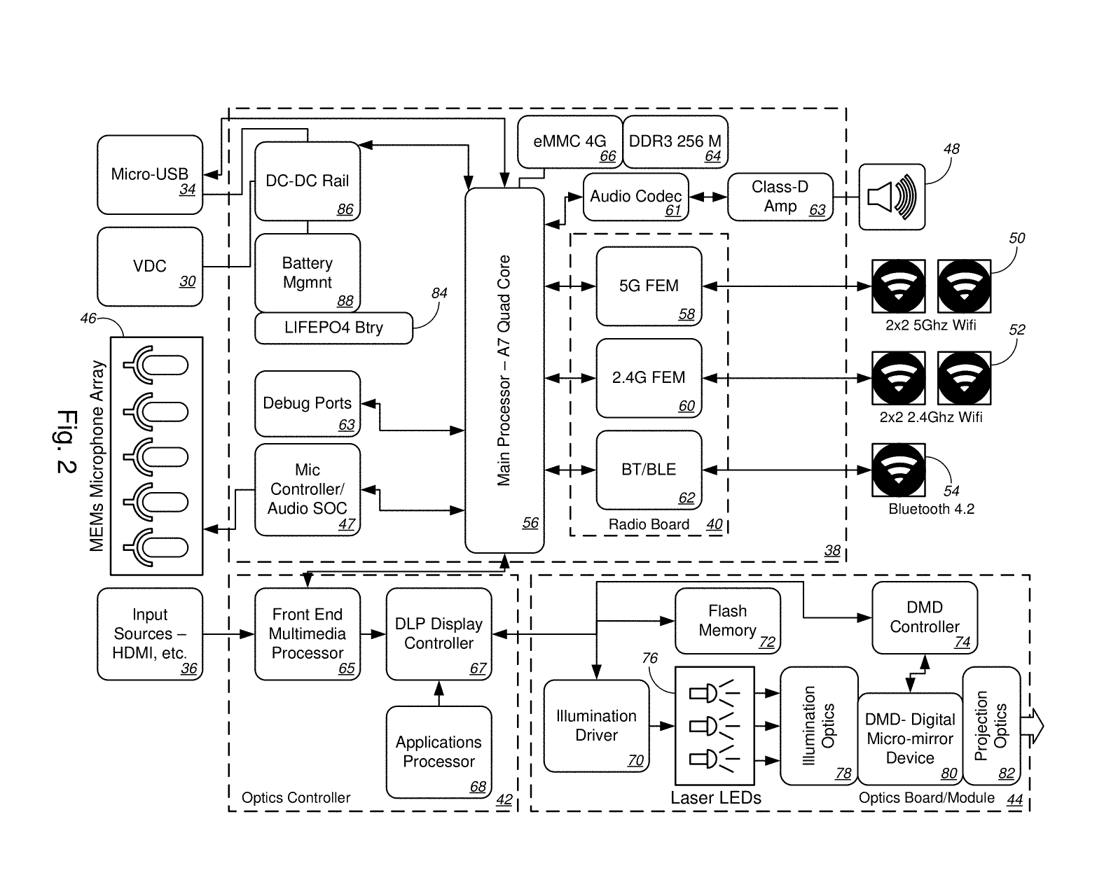

Certain electronic subsystems and components providing STB, video and audio projection, and IoT control functionality will be described with respect to FIG. 2. Each of the components or subsystems described herein is positioned within, on, or extending through the housing 12 of the STB 10. Components may be functionally grouped on boards including, but not limited to, a main board 38, a radio board 40 and optics controller board 42, and an optics module 44. Although certain components are illustrated as being grouped on certain boards or in certain modules in FIG. 2, alternative embodiments can be configured in any suitable manner.

As noted above, various input devices provide for audio, visual, radio, optical or electronic communication to or from the STB 10. One type of input device is audio-based. Therefore the STB 10 may include one or more microphones, for example the microphone array 46 illustrated in FIG. 2. The microphone or microphone array 46 of selected embodiments may communicate with the environment outside of the STB 10 through dedicated or multipurpose openings, for example through ventilation slots 16 as shown in FIG. 1. Alternatively, the microphone array may communicate with the environment outside of the STB 10 directly through the housing 12.

In operation, a user might interact with the STB 10 via the microphones 46 through the audio input processor 47. In some embodiments, the microphones 46 might comprise at least one of microelectromechanical systems (“MEMS”) microphones, dynamic (or electromagnetic-induction-based) microphones, condenser (or capacitance-change-based) microphones, piezoelectric microphones, carbon microphones, ribbon microphones, fiber optic microphones, laser microphones, liquid microphones, and/or the like. The audio input processor 47 might utilize far-field voice recognition, voice distinction, or a beam forming microphone array of the plurality of microphones 46, or a combination of these techniques to accurately and consistently distinguish the user's voice input despite the user being distant from the STB 10, despite the user's voice being low in volume, or despite the user's voice being mixed with ambient or other noises in the room or nearby. In some cases, the audio processor 47 might support voice activity detection (e.g., the use of wake word detection with barge-in support, or the like), enhanced voice recognition (which might be optimized for a microphone array configuration), speaker enhancement (which might include, but is not limited to, volume extension techniques, bass extension techniques, distortion protection techniques, etc.), and/or similar techniques to enhance voice detection and processing. The audio input function is optionally active based upon whether or not the mute button, for example, is simultaneously activated.

The STB also includes one or more speakers 48 positioned to transmit acoustic energy to the environment outside of the STB 10. In one embodiment, at least one speaker 48 is downward firing toward a base reflex cone 20 incorporated into the stand 18 supporting the STB 10. As noted above, the base reflex cone 20 serves to disperse sound from the speaker 48 in an acoustically advantageous manner. For example, the base reflex cone 20 may provide for wide angle acoustic dispersion in a horizontal plane to more effectively fill a listening area with sound or to simulate surround sound.

The STB 10 includes any number of electronic input ports including but not limited to one or more USB ports 34, one or more input or output HML/HDMI video interface ports 36 and a VDC charging port 30 or similar apparatus. Radio frequency input and output from the STB 10 may be received or broadcast from one or more antenna or antenna arrays. For example, the STB 10 may include an internal or external 2×2, 4×4 or other 5 Ghz WiFi antenna array 50, a 2×2, 4×3 2.4 or other Ghz WiFi antenna array 52, and/or a Bluetooth antenna array 54. The described ports and antenna arrays are merely representative configurations utilizing representative wireless communications frequencies. The STB 10 may include other antenna configurations and be enabled to transmit and receive radio frequency signals of any type used now or in the future. Any antenna array will be in communication with an appropriate transceiver device. For example, 5 G transceiver 58, the 2.4 G transceiver 60, and the Bluetooth transceiver 62 illustrated on the radio board 40 in communication with the corresponding antenna arrays.

As illustrated in FIG. 2, the main board 38 may include a processor 56 in communication with various other system components. For example, the processor may be in communication with various wireless transceivers including but not limited to the 5G transceiver 58, the 2.4 G transceiver 60, and the Bluetooth transceiver 62 illustrated on the radio board 40.

The processor 56 may also communicate with various memories including but not limited to SDRAM memory 64 and/or eMMC memory 66. The memories may store application programs, firmware, software, or other instructions providing for the control of the processor in various other components of the STB 10 as described in detail below. The processor 56 may further communicate data with various inputs or ports, including but not limited to one or more USB ports 34, or one or more HDMI ports 36. The processor may also control audio output through one or more audio CODECs 60, and amplifier 62, for example a class-D amplifier providing power savings and a small form factor, driving speaker 48. The processor may also receive input from the audio input processor 47 or various auxiliary inputs including but not limited to debug port 63 and the like.

The processor also communicates with the optics controller subsystem 42 which includes one or more multimedia processors 64, one or more display controllers 66, which can be a DLP display controller, and optionally, a separate video applications processor 68. Signals or data generated in the optics controller 42 can be communicated to the optics module 44. Alternatively, video signals can be communicated to a separate monitor through a wired or wireless connection. At the optics module 44, video signals are further processed to provide for optical projection from the projector 28 extending through (or optically projecting through) an opening or window in the housing 12 of the STB 10. The opening or window could also be used to manually apply optical adjustments to the projected image such as focus and/or contrast adjustments.

The projector 28 may be implemented with any suitable projection technology. In one representative example, illustrated in FIG. 2, the projector 28 is a laser micromirror device. Thus, the projector includes an illumination driver in communication with flash memory 72 and a digital micromirror device (DMD) controller 74. The flash memory may store application programs, diagnostics, firmware, software or other data to control the projector 28. The illumination driver 70 controls the output of an illumination source, for example red, green, and blue LEDs 76. Output from the red, green, and blue LEDs 76 is optically modified by illumination optics 78, and a digital micromirror device 80 under the control of DMD controller 74. Output from the digital micromirror device 80 is further modified by projection optics 82 to produce projected video output.

In certain embodiments, the optics controller subsystem 42 may communicate with and control a supplemental virtual reality (VR) or augmented reality (AR) display device connected through, for example the USB port 34 or HDMI port 36.

Power for all operations of the portable STB 10 may be supplied from a suitable rechargeable battery 84, for example an LiFePO₄ battery, or the like. The battery 84 may be charged with a charger connected to DC input jack 30. Alternatively, power to all subsystems may be directly supplied from an external power supply connected at DC input jack 30. Thus, the STB 10 may include a DC-DC rail 86 receiving power selectively from an external power supply or the battery 84. Battery charging control may be provided by battery management module 88.

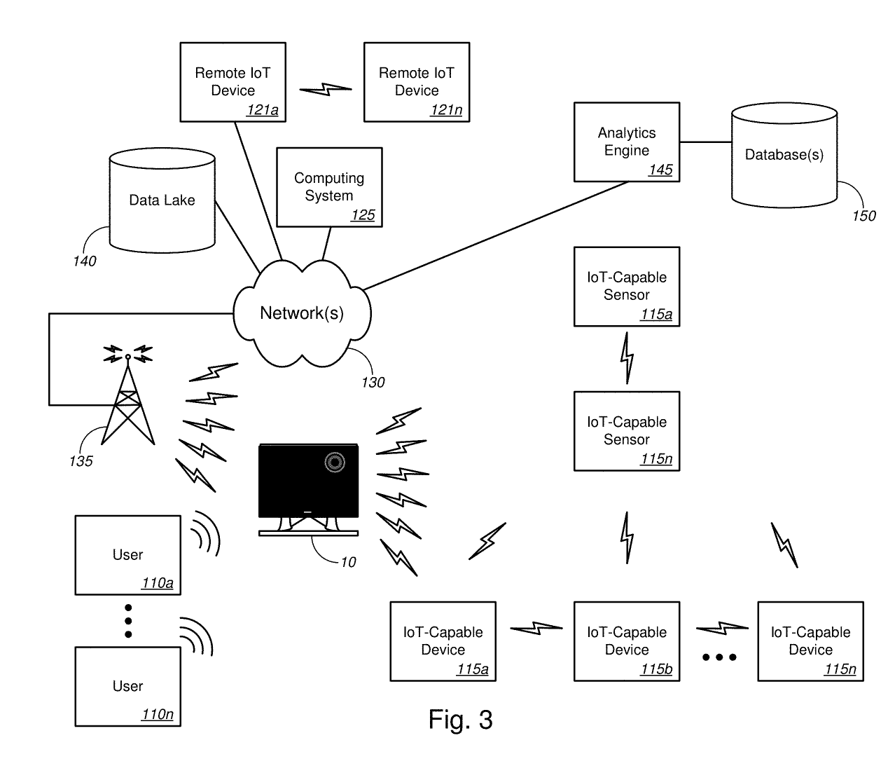

FIG. 3 is a schematic diagram illustrating various systems 100 for implementing Internet of Things (“IoT”) human interface functionality, using the STB 10, in accordance with various embodiments. In the non-limiting embodiments of 3, system 100 might include, without limitation, an STB 10, one or more users 110a-110n (collectively, “users 110”), one or more IoT-capable sensors 115a-115n (collectively, “IoT-capable sensors 115” or “sensors 115”), and one or more local IoT-capable devices 120a, 120b, through 120n (collectively, “local IoT-capable devices 120” or “devices 120”), and one or more remote IoT capable devices 121a-121n (collectively referred to herein as “remote IoT devices 121”).

In some embodiments, the IoT-capable sensors 115 might include, but are not limited to, one or more temperature sensors, one or more light sensors, one or more humidity sensors, one or more motion sensors, one or more air quality sensors, one or more carbon monoxide sensors, one or more smoke detectors, one or more water leak detectors, one or more contact sensors, one or more audio sensors, one or more accelerometers, one or more proximity sensors, one or more biometrics sensors, one or more location sensors, one or more radiation sensors, one or more telecommunications signal sensors, or one or more cameras, and/or the like. In some instances, the local IoT-capable devices 120 or remote IoT capable devices 121 might include, without limitation, one or more sensor devices, one or more household appliances, one or more kitchen appliances, one or more lighting systems, one or more automated door locking systems, one or more automated door opening or closing systems, one or more automated window locking systems, one or more automated window opening or closing systems, one or more smart windows, one or more window covering control systems, one or more solar cells, one or more customer premises security systems, one or more customer premises environmental control systems, one or more electrical outlets, one or more power strips, one or more dimmer switches, one or more data ports, one or more display devices, one or more clocks, one or more sprinkler systems, one or more vehicles, one or more mobile user devices, one or more media recording or playback devices, one or more medical devices, one or more fitness trackers, or one or more exercise equipment, and/or the like. In some cases, the at least one of the one or more sensor devices and at least one IoT-capable sensor 115 might be the same device,

According to some embodiments, system 100 might further comprise a computing system 125 that may be communicatively coupled, in a highly secure fashion, to at least the STB 10 (and in some cases, one or more of the sensors 115 or one or more of the devices 120) via network 130 (and in some instances, via one or more telecommunications relay systems 135). In some cases, the computing system 125 might include, but is not limited to, a server computer remote from the STB, a cloud computing system, a distributed computing system, and/or the like. In some instances, the network 130 might include, without limitation, one of a fiber network, an Ethernet network, a Token-Ring™ network, a wide-area network (“WAN”), a wireless wide area network (“WWAN”), a virtual private network (“VPN”), the Internet, an intranet, an extranet, a public switched telephone network (“PSTN”), an infra-red network, a wireless network operating under any of the IEEE 802.11 suite of protocols, the Bluetooth™ protocol known in the art, the Z-Wave protocol known in the art, the ZigBee protocol or other IEEE 802.15.4 suite of protocols known in the art, and/or any other wireless protocol, and/or any combination of these and/or other networks. In a particular embodiment, the network 130 (or multiple linked networks 130) might include an access network of the service provider (e.g., an Internet service provider (“ISP”)), or the like. The one or more telecommunications relay systems 135 might include, without limitation, one or more wireless network interfaces (e.g., wireless modems, wireless access points, and the like), one or more towers, one or more satellites, and/or the like. According to some embodiments, one or more of the STB 10, IoT-capable sensors 115, and/or the IoT-capable devices 120, 121 might each comprise a software-defined multiple radio device or other multiple radio device (e.g., multiple radio devices that comprise multiple physical layer chipsets or the like) that allows each of these devices to simultaneously operate in several standards and frequencies, including, but not limited to, Wi-Fi, LTE, IoT standards (like 6LowPAN, LoRa, etc.). In this manner, these devices might each serve as an access point, small cell, and IoT base, simultaneously, with the same RF transmit stage.

In some embodiments, the system 100 might further comprise a data store or data lake 140 that stores information regarding the STB 10, information regarding the IoT-capable sensors 115, information regarding the IoT-capable devices 120, 121, information regarding communications amongst these devices and sensors, information regarding communications between each of the users 110 and the STB 10, information regarding the network, information regarding communications between the computing system 125 and each of the STBs 10, the IoT-capable sensors 115, and the IoT-capable devices 120, 121, and/or the like. In some cases, the system 100 might further comprise an analytics engine 145 and an associated database 150 that together analyze and track (or record) communications amongst the various components of system 100 (i.e., the STB 10, the users 110, the IoT-capable sensors 115, the IoT-capable devices 120 121, the computing system 125, and/or the like) to identify trends as well as to identify potential issues with communications or efficiency of the system, and/or the like, the results of which might cause the computing system 125 to send software updates to affected or applicable ones of the STB 10, the IoT-capable sensors 115, the IoT-capable devices 120, 121, and/or the like.

In operation, the user 110 might interact with the STB 10 either via voice interaction (as shown, e.g., by the wave icons between each of the users 110 and the STB 10, or the like) or via interaction through an application running on a separate computing platform such as a mobile phone (connected to the STB via the network), user interface, user input device, keyboard, remote control, mouse and/or portal on the user's user device. In the case of voice commands being received from the user 110, one or each of a plurality of microphones 46 of the STB 10 might receive the voice input from the user 110, and the STB 10 and/or a computing system 125 might identify and process one or more explicit or implicit commands in the voice input. The voice input may also be received over the network through the aforementioned application.

The machine-to-machine communications between the STB 10 and each of the IoT-capable sensors 115a-115n, between the STB 10 and each of the IoT-capable devices 120, 121 are represented in FIG. 3 by the lightning bolt symbols, which in some cases denotes wireless communications (although, in some instances, need not be wireless, but can be wired communications). In some instances, each IoT-capable device of the plurality of IoT-capable devices 120, 121 and each IoT-capable sensor of the plurality of IoT-capable sensors 115a-115n might be assigned a unique IPv6 identifier or the like that enables secure and non-confused communications with particular IoT-capable devices or sensors (as no two devices or sensors will have the same identifier) In some cases, the IPv6 identifiers may be used together with other identifiers for the same device. In some instances, such identification capability can simplify device registration and/or can be used to facilitate machine-to-machine communications, machine-to-network communications, and/or the like.

According to some embodiments, one or more application programming interfaces (“APIs”) might be established between the STB 10 and each of the IoT-capable sensors 115a-115n, and between the STB 10 and each of the IoT-capable devices 120, 121. The APIs facilitate communications with these IoT-capable devices, which could number in the thousands or more. In some embodiments, artificial intelligence (“AI”) may be utilized in the STB 10 to improve interactions with the user, as well as improving machine-to-machine interactions between the STB 10 and each of the IoT-capable or device to improve utilization of the IoT-capable sensors 115 and the IoT-capable devices.

In some embodiments, the STB 10 might provide one or more of the following basic voice functionalities: support a variety of future voice services; enable IoT stack-enabled voice interface; control functionalities/devices in a customer premises; control remote functionalities/devices over a network or the Internet, respond to user questions; announce news headlines; announce sports scores; play high-quality music; provide voice activated smart speaker functionality; and/or the like. According to some embodiments, the STB 10 might provide one or more of the following improved or advanced voice functionalities: provide speaker and microphone functionalities with far-field voice recognition with microphone beam-forming; enable capturing a particular user's voice from across a room even during music playback; enable accurately picking out a particular user's voice even when the user is far from the STB 10 and is speaking at a normal volume in a noisy room; enable selection between hands-free, always on, always listening functionality or push-to-talk/push-to-listen functionality; enable functionality of push-to-talk apps from mobile devices; provide hardware and software that are optimized for far-field stationary home use; enable voice activity detection (e.g., barge-in support that utilizes a “finger printing” (or voice printing) of a wake-up word or phrase, etc.); enable enhanced voice recognition that is optimized for array microphone configuration (which might include auto-tuning to a room to learn voices and ambient noises, etc.); provide speaker enhancement (e.g., volume extension (e.g., small speaker tuning), bass extension, distortion protection (e.g., noise cancellation), etc.); and/or the like.

According to some embodiments, the STB 10 might provide one or more of the following operations: autonomous, machine-to-machine software/firmware updates; remote login and control; system health/remote alarm functionalities; and/or the like. In some cases, the STB 10 might provide one or more of the following functionalities: provide smart home control or lifestyle automation and query (that covers thousands of devices or more); provide cloud intelligence (e.g., ability to support local and remote sites, etc.); provide improved WiFi connectivity with beam forming antennas; enable IoT stack universal apps (including, but not limited to, setup apps, control apps, configuration apps, user automation apps, etc.); enable “out-of-box” experience (e.g., by utilizing automated initial set-up or configuration, by utilizing bar-code-based initial set-up or configuration, etc.); provide live resiliency (that enables functionality in case of dropped or no network connectivity); provide live view (that provides automatic updates in real-time); provide live sync (that provides a common view for multiple users); provide live aware or awareness (that provides status of network elements and provides proactive solutions to anticipated or current network issues or problems); utilize IoT stack automation engine (that allows quick and easy creation of virtually any kind of automation task, that makes available as both a trigger and an action any functionalities of any IoT-capable device, that enables end users to add innovative new use cases, etc.); provide IoT stack system for app and systems external development (that provides fully customizable apps and user interfaces, that enables robust API/protocol abstraction, that provides a developer program kit, that enables any-platform support (i.e., that makes the IoT human interface device agnostic to systems, platforms, and IoT-capable devices, etc.), etc.; provide security (e.g., AES 256-bit encryption capability or better, OAuth 2.0 or better for client authentication, security enhancement (e.g., LED lights flash red when the fire alarm goes off, etc.)), etc.; provide voice security (e.g., using network address translation (“NAT”) for devices, provide security for IoT apps and API, enable ability to lock the system so no changes can be made, enable parental control functionalities, enable voice authentication via texted security code, etc.); and/or the like. Herein, “IoT stack” might refer to a management or coordination engine that could be embodied within the computing system 125, within the STB 10, within a cloud computing system (not shown), within a distributed computing system, and/or the like. The IoT stack handles, coordinates, and/or manages IoT communications and interactions amongst a plurality of IoT-capable devices and sensors (and, in some instances, all IoT devices within the customer premises or local network; or, in other cases, all IoT devices within a service provider's network covering a plurality of customer premises and subscribers/users) that are communicatively coupled to the service provider network that is associated with the IoT stack and/or to any network with which the IoT stack is in communication. In some embodiments, quantum security methods may be utilized to protect network access (IoT device access, STB access), data and user privacy.

In some embodiments, the STB 10 might provide one or more of the following additional functionalities: provide condition-based action functionalities (e.g., utilizing if-this-then-that-logic, etc.); enable learning intent parsing (that determines user intent, matches possibility/probability levels, and provides tag listing of devices); provide desktop as a service functionality; provide software as a service functionality; enable one touch/button functionality for adding new IoT-capable devices; store historical data (including, but not limited to, how long the connection has been up in the last day, last 10 days, etc.; signal strength; protocol used by each device; etc.) from each IoT-capable device in a built-in large cache or solid state hard drive; enable bulk uploading of information into cloud storage for off-hours download of data from all IoT-capable devices in the network; support all IoT protocols (including, but not limited to, Zwave, MQTT, CoAP, AMQP, XMPP, etc.); provide ability to block one or more IoT-capable devices from communicating with the IoT-human interface device; support more than 250 IoT-capable devices at a time; and/or the like.

Merely by way of example, in sonic embodiments, the STB 10 might provide voice over Internet Protocol (“VoIP”) functionality, in some cases, using a voice interface rather than a numeric keypad interface or the like to establish or connect a call using VoIP, or the like. In some cases, the STB 10 might utilize active authentication as a security measure prior to following commands by the user. In such cases, the STB 10 (or an AI module thereof) might learn how a particular user interacts with one or more devices—e.g., word usage, phrase usage, keystroke patterns, etc.—, and might block user access if subsequent interaction is determined to be different (i.e., determined to be by someone other than the purported user), and/or the like. Other security measures might include, but are not limited to, utilizing security mode interaction with other devices, utilizing voice recognition, voice input, or other authentication to open/unlock doors, and/or the like.

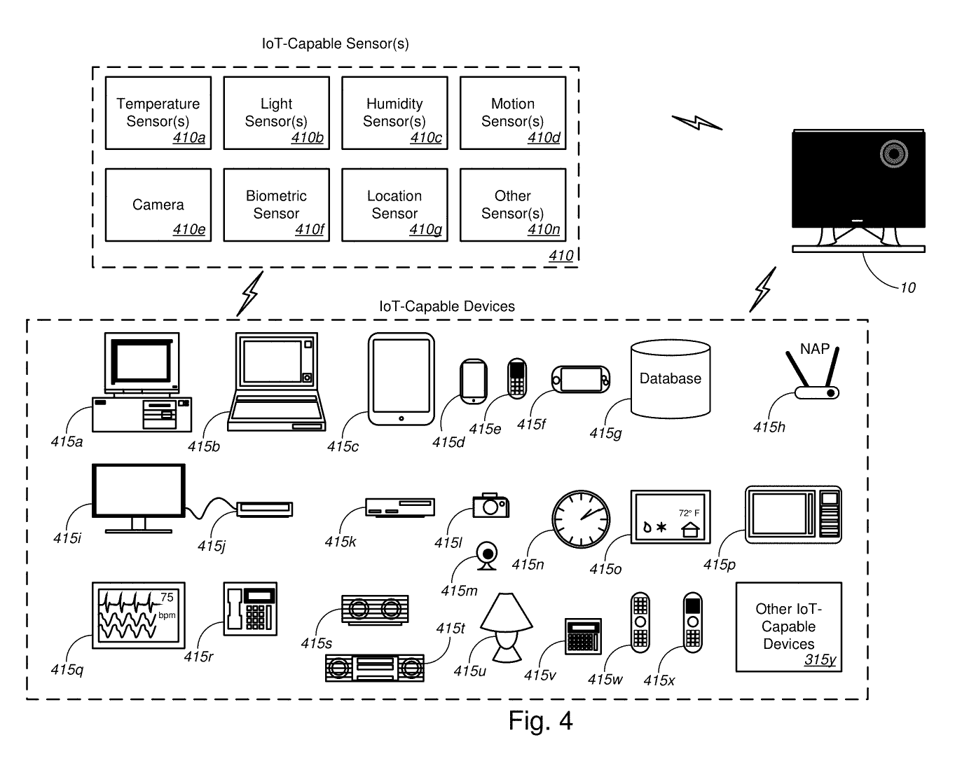

FIG. 4 is a schematic diagram illustrating yet another system 400 for implementing IoT human interface functionality with the STB 10, in accordance with various embodiments. In particular, FIG. 4 depicts various examples of IoT-capable sensors 410 and various examples of IoT-capable devices 415 with which the STB 10 communicates. Some IoT-capable sensors 410, in some cases, also communicate with some IoT-capable devices 415. Although lightning bolt symbols are used to denote wireless communications between two or more of the STB 10, the IoT-capable sensors 410, and the IoT-capable devices 415, the various embodiments are not so limited, and wired as well as wireless communications may be used. In any event, most communications would be autonomous machine-to-machine communications.

According to some embodiments, the IoT-capable sensors 410 might include, without limitation, one or more temperature sensors 410a (e.g., heat sensors, infrared sensors, thermometers, etc.), one or more light sensors 410b (e.g., ambient light sensors, luminosity sensors, illuminance sensors, etc.), one or more humidity sensors 410c, one or more motion sensors 410d, one or more cameras 410e, one or more biometric sensors 410f (e.g., fingerprint sensors, palm print sensors, footprint sensors, handprint sensors, voice identification sensors, iris scanners, retina scanners, etc.), one or more location sensors 410g (e.g., global positioning system (“GPS”) devices, global navigation satellite system (“GLASS”) devices, other location sensors, etc.), one or more other sensors 410h, and/or the like. In some cases, the one or more other sensors 410h might include, but are not limited to, one or more air quality sensors, one or more carbon monoxide sensors, one or more smoke detectors, one or more water leak detectors, one or more contact sensors, one or more audio sensors, one or more accelerometers, one or more proximity sensors, one or more radiation sensors, one or more telecommunications signal sensors, and/or the like.

In some embodiments, the MT-capable devices 415 might include one or more IoT-capable sensors 410 and/or might further include, without limitation, a desktop computer 415a, a laptop computer 415b, a tablet computer 415c, a smart phone 415d, a mobile phone 415e, a portable gaming device 415f, a database or data storage device 415g, a network access point (“NAP”) 415h, a television or monitor 415i, a set-top box (“STB”) 415j, a gaming console 415k, an image capture device 415l, a video capture device 415m, a time piece 415n (including, without limitation, a clock, a watch, or other time piece, and the like), a thermostat or environmental control system 415o, a kitchen appliance 415p (including, but not limited to, a microwave oven, a refrigerator, an oven, a range, a stove, an induction cooktop, a pressure cooker, a rice cooker, a bread maker, a coffee machine, a kettle, a dishwasher, a food thermometer, and/or the like), a medical device 415q, a telephone system 415r, a speaker 415s, a media recording and/or playback device 415t, a lighting system 415u, a customer premises security control system 415v, one or more dedicated remote control devices 415w, one or more universal remote control devices 415x, and/or other IoT-capable devices 415y. In some cases, the other MT-capable devices 415y might include, without limitation, a personal digital assistant, a fitness tracking device, a printer, a scanner, an image projection device, a video projection device, a household appliance, a vehicle, an audio headset, earbuds, virtual reality goggles or headset, augmented reality goggles or headset, a door locking system, an automated door opening/closing system, a window locking system, an automated window opening or closing system, a window covering control system, a smart window, a solar cell or solar cell array, an electrical outlet or smart node, a power strip or bar, a dimmer switch, a data port, a sprinkler system, exercise equipment, and/or the like.

The STB 10, the IoT-capable sensors 410, and the IoT-capable devices 415 are otherwise similar, if not identical, to the STB 10, the IoT-capable sensors 115, and the IoT-capable devices 120, 121, respectively, as described above with respect to FIGS. 1-4.

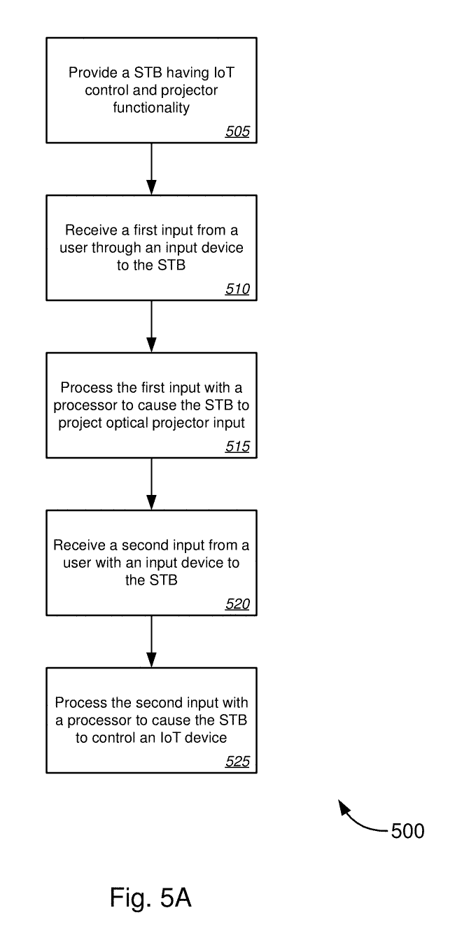

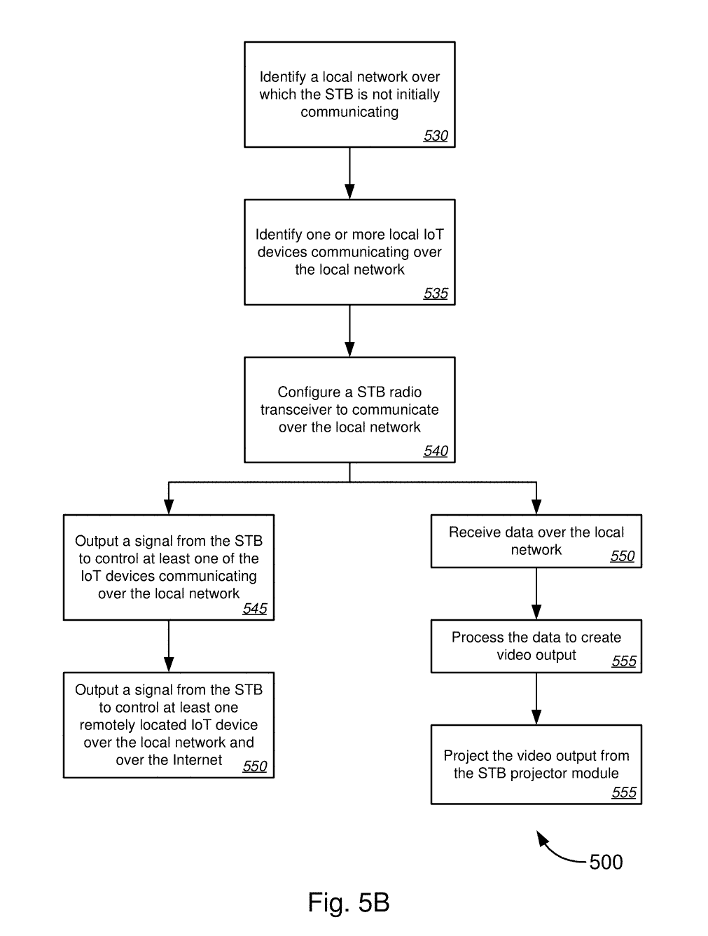

FIG. 5A and 5B (collectively, “FIG. 5”) are flow diagrams illustrating methods for implementing IoT control and video projection functionality, in accordance with various embodiments. While the techniques and procedures are depicted and/or described in a certain order for purposes of illustration, it should be appreciated that certain procedures may be reordered and/or omitted within the scope of various embodiments. Moreover, while the methods illustrated by FIG. 5 can be implemented by or with (and, in some cases, are described below with respect to) the systems 100 and 400 of FIGS. 3 and 4 respectively (or components thereof), such methods may also be implemented using any suitable hardware (or software) implementation. Similarly, while each of the systems 100 and 400, or the STB 10 of FIGS. 1-4 (or components thereof), can operate according to the methods illustrated by FIG. 5 (e.g., by executing instructions embodied on a computer readable medium), the systems 100 and 400 can each also operate according to other modes of operation and/or perform other suitable procedures.

In FIG. 5A, method 500, at block 505, generally comprises providing STB, for example STB 10, having at least IoT control and integrated projector functionality. Method 500 further includes receiving a first input from a user through an input device to the STB (Step 510). The input device may be any manner of switch, keyboard, remote control, or, in certain embodiments, a microphone 46 receiving voice commands or similar apparatus. At block 515, method 500 includes processing the first input with a processor to cause the STB to project optical output from the projector 28. For example, the processed input may cause the STB 10 to project a movie, still images, or other image(s) with the projector 28. Alternatively, the processed input may cause the STB 10 to project data and images such as would typically be displayed on a computer screen. At block 520 the method includes receiving a second input from the user to the STB 10. The second input is processed with a processor to cause the STB to control an IoT device 120, 120, or 415 according to any process described herein (Step 525.)

As noted above, STB 10 is a fully integrated and portable device. Thus, a user of STB 10 may transport the STB 10 from place to place in much the way that a conventional laptop computer is transported. Method 502 of FIG. 5B contemplates an environment where a user has transported STB 10 to a location where the STB 10 has not yet been connected to a network. Accordingly, step 530 of method 502 includes identifying, with the STB 10, a local network over which the STB 10 is not initially communicating. In addition, the STB 10 may identify one or more local IoT devices communicating over the identified local network (Step 535). The STB 10 may then configure one or more STB radio transceivers, for example transceivers 58, 60, or 62 to communicate over the local network (Step 540). Alternatively, the STB 10 may configure communications with any number of IoT devices using, for example Bluetooth or another direct wireless communications method. There may also be a need to establish geographical proximity to the different IoT devices given the movement of the STB.

Communication over the local network may involve both data or signal download and upload processes. For example, a signal may be output from the STB to control at least one of the IoT devices communicating over the local network. (Step 545). Alternatively, the STB 10 may receive video data, computer files, or other data that can be displayed from the local network. (Step 550). Data received over the local network may be processed by the STB tend to produce video output as described herein (Step 550). Subsequently, at Step 560 the processed video output may be projected from the projector 28 of the STB 10.

As noted above, the STB 10 may also be utilized to control a remote IoT device over the local network (or various local networks) and the Internet (Step 565). Similarly, data from a remote location may be transmitted to the STB 10 over any number of inter-communicating networks, including the Internet.

### Exemplary System and Hardware Implementation

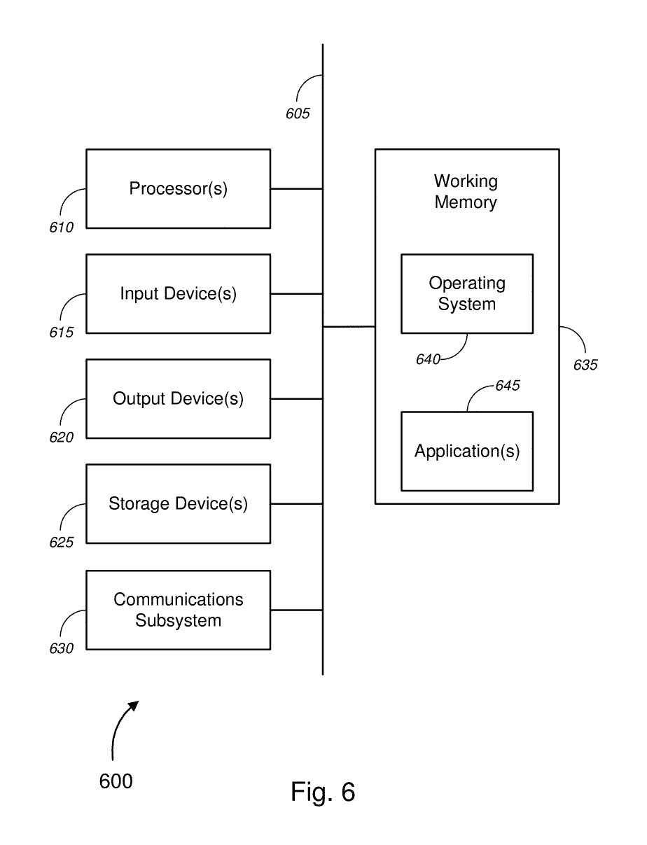

FIG. 6 is a block diagram illustrating an exemplary computer or system hardware architecture, in accordance with various embodiments. FIG. 6 provides a schematic illustration of one embodiment of a computer system 600 of the service provider system hardware that can perform the methods provided by various other embodiments, as described herein, and/or can perform the functions of computer or hardware system (i.e., STB 10, IoT-capable sensors 115a-115n, 410, and 410a-410h. IoT-capable devices 120a-120n, 415, and 415a-415y, computing system 125, analytics engine 145, etc.) or user devices as described above. It should be noted that FIG. 6 is meant only to provide a generalized illustration of various components, of which one or more (or none) of each may be utilized as appropriate. FIG. 6, therefore, broadly illustrates how individual system elements may be implemented in a relatively separated or relatively more integrated manner.

The computer or hardware system 600 which might represent an embodiment of the computer or hardware system (i.e., IoT STB 10, IoT-capable sensors 115a-115n, 410, and 410a-410h, IoT-capable devices 120a-120n, 415, and 415a-415y, computing system 125, analytics engine 145, etc.) or user devices described above with respect to FIGS. 1-5—is shown comprising hardware elements that can be electrically coupled via a bus 605 (or may otherwise be in communication, as appropriate). The hardware elements may include one or more processors 610, including, without limitation, one or more general-purpose processors and/or one or more special-purpose processors (such as microprocessors, digital signal processing chips, graphics acceleration processors, and/or the, like); one or more input devices 615, which can include, without limitation, a mouse, a keyboard, and/or the like; and one or more output devices 620, which can include, without limitation, a display device, a printer, and/or the like.

The computer or hardware system 600 may further include (and/or be in communication with) one or more storage devices 625, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer or hardware system 600 might also include a communications subsystem 630, which can include, without limitation, a modem, a network card (wireless or wired), an infra-red communication device, a wireless communication device and/or chipset (such as a Bluetooth™ device, an 802.11 device, a WiFi device, a WiMax device, a WWAN device, LPWAN, a Z-Wave device, a ZigBee device, cellular communication facilities, etc.), and/or the like. The communications subsystem 630 may permit data to be exchanged with a network (such as the network described below, to name one example), with other computer or hardware systems, and/or with any other devices described herein. In many embodiments, the computer or hardware system 600 will further comprise a working memory 635, which can include a RAM or ROM device, as described above.

The computer or hardware system 600 also may comprise software elements, shown as being currently located within the working memory 635, including an operating system 640, device drivers, executable libraries, and/or other code, such as one or more application programs 645, which may comprise computer programs provided by various embodiments (including, without limitation, hypervisors, VMs, and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 625 described above. In some cases, the storage medium might be incorporated within a computer system, such as the system 600. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer or hardware system 600 and/or might take the form of source and/or installable code, which, upon compilation and/or installation on the computer or hardware system 600 (e.g., using any of a variety of generally available compilers, installation programs, compression/decompression etc.) takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 600) to perform methods in accordance with various embodiments of the invention. According to a set of embodiments, some or all of the procedures of such methods are performed by the computer or hardware system 600 in response to processor 610 executing one or more sequences of one or more instructions (which might be incorporated into the operating system 640 and/or other code, such as an application program 645) contained in the working memory 635. Such instructions may be, read into the working memory 635 from another computer readable medium, such as one or more of the storage device(s) 625. Merely by way of example, execution of the sequences of instructions contained in the working memory 635 might cause the processor(s) 610 to perform one or more procedures of the methods described herein.

The terms “machine readable medium” and “computer readable medium,” as used herein, refer to any medium that participates in providing data that causes a machine to operate in a specific fashion. In an embodiment implemented using the computer or hardware system 600, various computer readable media might be involved in providing instructions/code to processor(s) 610 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 625. Volatile media includes, without limitation, dynamic memory, such as the working memory 635. In some alternative embodiments, a computer readable medium may take the form of transmission media, which includes, without limitation, coaxial cables, copper wire and fiber optics, including the wires that comprise the bus 605, as well as the various components of the communication subsystem 630 (and/or the media by which the communications subsystem 630 provides communication with other devices). In an alternative set of embodiments, transmission media can also take the form of waves (including, without limitation, radio, acoustic, and/or light waves, such as those generated during radio-wave and infra-red data, communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 610 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 600. These signals, which might be in the form of electromagnetic signals, acoustic signals, optical signals, and/or the like, are all examples of carrier waves on which instructions can be encoded, in accordance with various embodiments of the invention.

The communications subsystem 630 (and/or components thereof) generally will receive the signals, and the bus 605 then might carry the signals (and/or the data, instructions, etc. carried by the signals) to the working memory 635, from which the processor(s) 605 retrieves and executes the instructions. The instructions received by the working memory 635 may optionally be stored on a storage device 625 either before or after execution by the processor(s) 610.

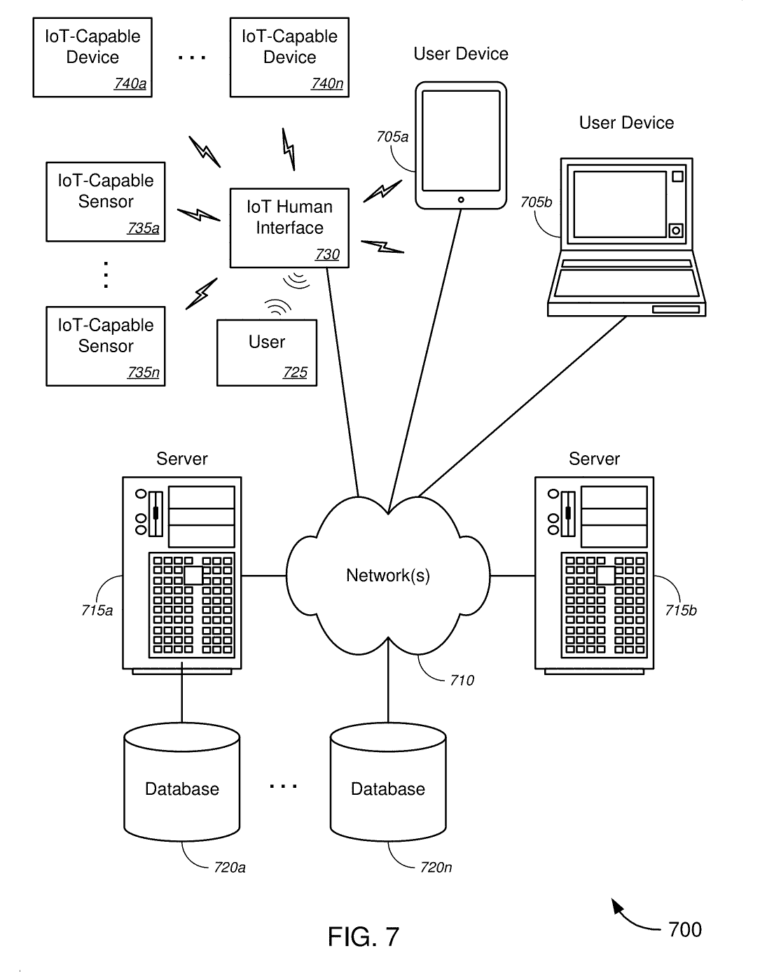

As noted above, a set of embodiments comprises methods and systems for implementing video projection and Internet of Things functionality, and, in particular embodiments, methods, systems, apparatus, and computer software for implementing Internet of Things (“IoT”) human interface functionality using the STB 10. FIG. 7 illustrates a schematic diagram of a system 700 that can be used in accordance with various embodiments. The system 700 can each include one or more user computers, user devices, or customer devices 705. A user computer, user device, or customer device 705 can be a general purpose personal computer (including, merely by way of example, desktop computers, tablet computers, laptop computers, handheld computers, and the like, running any appropriate operating system, several of which are available from vendors such as Apple, Microsoft Corp., and the like), cloud computing devices, a server(s), and/or a workstation computer(s) running any of a variety of commercially-available UNIX™ or UNIX-like operating systems. A user computer, user device, or customer device 705 can also have any of a variety of applications, including one or more applications configured to perform methods provided by various embodiments (as described above, for example), as well as one or more office applications, database client and/or server applications, and/or web browser applications. Alternatively, a user computer, user device, or customer device 705 can be any other electronic device, such as a thin-client computer, Internet-enabled mobile telephone, and/or personal digital assistant, capable of communicating via a network (e.g., the network(s) 710 described below) and/or of displaying and navigating web pages or other types of electronic documents. Although the exemplary system 700 is shown with two user computers, user devices, or customer devices 705, any number of user computers, user devices, or customer devices can be supported.

Certain embodiments operate in a networked environment, which can include a network(s) 710. The network(s) 710 can be any type of network familiar to those skilled in the art that can support data communications using any of a variety of commercially-available (and/or free or proprietary) protocols, including, without limitation, TCP/IP, SNA™, IPX™, AppleTalk™, and the like. Merely by way of example, the network(s) 710 (similar to network 130 of FIGS. 1 and 2, or the like) each include a local area network (“LAN”), including, without limitation, a fiber network, an Ethernet network, a Token-Ring™ network, and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, the Z-Wave protocol known in the art, the ZigBee protocol or other IEEE 802.15.4 suite of protocols known in the art, and/or any other wireless protocol; and/or any combination of these and/or other networks. In a particular embodiment, the network might include an access network of the service provider (e.g., an Internet service provider (“ISP”)). In another embodiment, the network might include a core network of the service provider, and/or the Internet.

Embodiments can also include one or more server computers 715. Each of the server computers 715 may be configured with an operating system, including, without limitation, any of those discussed above, as well as any commercially (or freely) available server operating systems. Each of the servers 715 may also be running one or more applications, which can be configured to provide services to one or more clients 705 and/or other servers 715.

Merely by way of example, one of the servers 715 might be a data server, a web server, a cloud computing device(s), or the like, as described above. The data server might include (or be in communication with) a web server, which can be used, merely by way of example, to process requests for web pages or other electronic documents from user computers 705. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 705 to perform methods of the invention.

The server computers 715, in some embodiments, might include one or more application servers, which can be configured with one or more applications accessible by a client running on one or more of the client computers 705 and/or other servers 715. Merely by way of example, the server(s) 715 can be one or more general purpose computers capable of executing programs or scripts in response to the user computers 705 and/or other servers 715, including, without limitation, web applications (which might, in some cases, be configured to perform methods provided by various embodiments). Merely by way of example, a web application can be implemented as one or more scripts or programs written in any suitable programming language, such as PHP, Java™, C, C#™ or C++, and/or any scripting language, such as Perl, Python, or TCL, as well as combinations of any programming and/or scripting languages. The application server(s) can also include database servers, including, without limitation, those commercially available from Oracle™, Microsoft™, Sybase™, IBM™ and the like, which can process requests from clients (including, depending on the configuration, dedicated database clients, API clients, web browsers, etc.) running on a user computer, user device, or customer device 705 and/or another server 715. In some embodiments, an application server can perform one or more of the processes for implementing Internet of Things functionality, and in particular embodiments, to methods, systems, apparatus, and computer software for implementing Internet of Things (“IoT”) human interface functionality, or the like, as described in detail above. Data provided by an application server may be formatted as one or more web pages (comprising HTML, JavaScript, etc., for example) and/or may be forwarded to a user computer 705 via a web server (as described above, for example). Similarly, a web server might receive web page requests and/or input data from a user computer 705 and/or forward the web page requests and/or input data to an application server. In some cases, a web server may be integrated with an application server.

In accordance with further embodiments, one or more servers 715 can function as a file server and/or can include one or more of the files (e.g., application code, data files, etc.) necessary to implement various disclosed methods, incorporated by an application running on a user computer 705 and/or another server 715. Alternatively, as those skilled in the art will appreciate, a file server can include all necessary files, allowing such an application to be invoked remotely by a user computer, user device, or customer device 705 and/or server 715.

It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 720a-720n (collectively, “databases 720”). The location of each of the databases 720 is discretionary: merely by way of example, a database 720a might reside on a storage medium local to (and/or resident in) a server 715a (and/or a user computer, user device, or customer device 705). Alternatively, a database 720n can be remote from any or all of the computers 705, 715, so long as it can be in communication (e.g., via the network 710) with one or more of these. In a particular set of embodiments, a database 720 can reside in a storage-area network (“SAN”) familiar to those skilled in the art. (Likewise, any necessary files for performing the functions attributed to the computers 705, 715 can be stored locally on the respective computer and/or remotely, as appropriate.) In one set of embodiments, the database 720 can be a relational database, such as an Oracle database, that is adapted to store, update, and retrieve data in response to SQL-formatted commands. The database might be controlled and/or maintained by a database server, as described above, for example.

With reference to FIG. 7, according to some embodiments, system 700 might further comprise an IoT human interface device 730 (similar to STB 10 or 305 of FIGS. 1-4, or the like), one or more IoT-capable sensors 735a-735n (similar to IoT-capable sensors 115a-115n, 410, or 410a-410h of FIGS. 1-4, or the like), and one or more IoT-capable devices 740a-740n (similar to IoT-capable devices 120a-120n, 415 or 415a-415y of FIGS. 1-4, or the like).

In operation, a user 725 might interact with the IoT human interface device 730 either via voice interaction (as shown, e.g., by the wave icons between the user 725 and the IoT human interface device 730 in FIG. 7, or the like) or via interaction through an app, user interface, and/or portal on the user's user device (e.g., 705a, 705b, and/or the like; as shown, e.g., in the embodiments of FIGS. 5A-5I, or the like). In the case of voice commands from the user 725, each of a plurality of microphones of the IoT human interface device might receive the voice input from the user 725, and the IoT human interface device 730 and/or a computing system (e.g., server 715a, 715b, or some other computing system, or the like) might identify one or more explicit commands in the voice input; might identify one or more first IoT-capable devices of the plurality of IoT-capable devices 740a-740n to which the one or more explicit commands are applicable; might receive one or more first sensor data from each of at least one first sensor of the plurality of IoT-capable sensors 735a-735n; might analyze the first voice input in view of previous voice inputs from the user and in view of the one or more first sensor data, to determine whether the first voice input additionally contains any implicit commands; based on a determination that the first voice input contains at least one implicit command, might identify one or more second IoT-capable devices of the one or more first IoT-capable devices to which the at least one implicit command is additionally applicable, generate second instructions for each of the one or more second IoT-capable devices, using a combination of the one or more explicit commands and the at least one implicit command, and send the generated second instructions to the one or more second IoT-capable devices; and, for each of the one or more first IoT-capable devices to which the at least one implicit command is not applicable, might generate first instructions, using the one or more explicit commands, and send the generated first instructions to the one or more first IoT-capable devices to which the at least one implicit command is not applicable; and/or the like. The machine-to-machine communications between the MT human interface device 730 and each of the user devices 705a or 705b, the IoT-capable sensors 735a-735n, and the IoT-capable devices 740a-740n are represented in FIG. 7 by the lightning bolt symbols, which in some cases denotes wireless communications (although, in some instances, need not be wireless, but can be wired communications). These and other functions of the system 700 (and its components) are described in greater detail above with respect to FIGS. 1-5.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with or without certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A device comprising:
a processor;
an input device in communication with the processor;
a video projection module in communication with the processor;
a radio transceiver in communication with the processor; and
a non-transitory computer readable medium in communication with the processor, the non-transitory computer readable medium having stored thereon computer software comprising a set of instructions that, when executed by the processor, cause the device to:
receive a first input from a user with the input device, which first input is processed by the processor according to the instructions to cause the video projection module to project a video output; and
receive a second input from a user with the input device, which second input is processed by the processor according to the instructions to cause the radio transceiver to output a signal to control a separate Internet of Things (IoT) device.

2. The device of claim 1, wherein the input device comprises at least one microphone and wherein at least one of the first input and the second input is a voice command.

3. The device of claim 1 further comprising a battery positioned within the housing, wherein said battery provides power to the processor, input device, video projection module and radio transceiver.

4. The device of claim 1, wherein the instructions, when executed by the processor, cause the device to transmit a video signal to a separate video monitor.

5. The device of claim 1, wherein the instructions, when executed by the processor, cause the device to:
identify a local network over which the device is not initially communicating;
identify one or more IoT devices communicating over the local network;
configure the radio transceiver to communicate over the local network; and
output a signal to control at least one of the IoT devices communicating over the local network.

6. The device of claim 5 wherein the instructions, when executed by the processor, cause the device to output a signal to control at least one remotely located IoT device over the local network and over the internet.

7. The device of claim 5 wherein the instructions, when executed by the processor, cause the device to:
receive video data over the local network;
process the video data to create video output; and
project the video output from the projector module.

8. The device of claim 5, wherein the instructions, when executed by the processor, cause the device to operate as a wireless access point for the local network.

9. The device of claim 1, wherein the input device comprises a wireless keyboard.

10. The device of claim 1 further comprising:
an audio speaker; and
a device base supporting the device housing, wherein said device base comprises a reflecting surface configured to horizontally disperse audio output from the speaker.

11. A method, comprising:
providing a Set Top Box “STB” device comprising;
a processor;
an input device in communication with the processor;
a video projection module in communication with the processor;
a radio transceiver in communication with the processor; and
a non-transitory computer readable medium in communication with the processor, the non-transitory computer readable medium having stored thereon computer software comprising a set of instructions;
receiving a first input from a user with the input device;
processing the first input with the processor, according to the instructions, to cause the video projection module to project a video output;
receiving a second input from a user with the input device;
processing the second input with the processor, according to the instructions, to cause the radio transceiver to output a signal to control a separate Internet of Things (IoT) device.

12. The method of claim 11, further comprising:
providing an input device comprising at least one microphone; and
receiving at least one of the first input and the second input as a voice command.

13. The method of claim 11, further comprising:
providing a battery positioned within STB; and
powering the processor, input device, video projection module and radio transceiver with the battery.

14. The method of claim 11, further comprising:
receiving a third input from a user with the input device; and
processing the third input with the processor, according to the instructions, to cause the STB to output a video signal to a separate video monitor.

15. The method of claim 11, further comprising:
identifying a local network over which the STB is not initially communicating;
identifying one or more IoT devices communicating over the local network;
configuring the radio transceiver to communicate over the local network; and
outputing a signal to control at least one of the IoT devices communicating over the local network.

16. The method of claim 15, further comprising causing the STB to output a signal to control at least one remotely located IoT device over the local network and over the internet.

17. The method of claim 15, further comprising:
receiving video data over the local network;
processing the video data to create video output; and
projecting the video output from the projector module.

18. The method of claim 15, further comprising causing the STB to operate as a wireless access point for the local network.

19. The method of claim 11, further comprising causing the STB to accept input from a wireless keyboard.

20. The method of claim 11 further comprising:
providing the STB with an audio speaker;
providing the STB with a device base; and
reflecting audio output from the audio speaker off a reflecting surface of the device base to horizontally disperse the audio output.
